(19) United States
(12) Patent Application Publication
(10) Pub. No.: US 2016/0283875 A1
(43) Pub. Date: Sep. 29, 2016

(54) Risk Management Tool

(71) Applicant: Birdi & Associates, Inc., Pasadena, CA (US)

(72) Inventor: Moninder Singh Birdi, Alta Dena, CA (US)

(21) Appl. No.: 14/848,321

(22) Filed: Sep. 8, 2015

Related U.S. Application Data
(60) Provisional application No. 62/047,010, filed on Sep. 7, 2014.

(51) Int. Cl. G06Q 10/06; H04L 29/06

(52) U.S. Cl. CPC G06Q 10/0635; H04L 67/42

(57) ABSTRACT

Embodiments of the present invention may provide a risk management application for generating a risk management report. One or more risks associated with a design or construction phase of a project are identified. Project data is also received. Current and future conditions associated with the project are determined and risks that are related to the project are identified. A risk management report is created based on the identified risks.

### CROSS REFERENCE TO RELATED APPLICATION

The present application claims the priority benefit of U.S. provisional application No. 62/047,010 filed Sep. 7, 2014 and entitled “Risk Management in Major Facility Development Projects,” the disclosure of which is incorporated herein by reference.

### BACKGROUND

1. Field of the Invention

The present invention generally concerns project management and construction management. More particularly, the present invention relates to managing quality and mitigating cost and risks associated with a complex process, program or project.

2. Description of the Related Art

A large program or project is typically associated with multiple phases or stages, interested parties (i.e., stakeholders), and other complicated considerations. These considerations could concern operations, logistics, schedules, budgets, security issues, public safety, facility functions, and building materials to name but a few. A program, too, may include various projects. Phases of a project, in turn, may include planning/pre-design, design, bid process, construction, commissioning/start-up and close-out and other phases or sub-phases.

Various risks, such as those related to costs or scheduling, may arise during the lifecycle of a program or project. With a major facility development project, one type of systemic risk includes delays in activating systems and facilities. A facility may comprise multiple systems and subsystems including both physical and electronic components. For example, an airport terminal may include physical systems such as a security system, baggage transport system, and a network of roadways for access. The terminal may also include electronic systems and subsystems. A security system may include a network of security cameras and electronic systems/software for verifying identity (i.e. software that processes fingerprints or retinal scans or performs facial recognition).

New or necessary facilities and systems are often not fully operational or apparent at the opening day of a project. For example, in constructing an airport terminal, critical inefficiencies in the security or transport of baggage may not be realized on day one. It may take many months and the examination of complaints or errors before such inefficiencies are discovered. Often times, the need for necessary or improved facilities or systems are discovered and then implemented after construction is complete and the facility is open for operations. A related systemic risk includes the loss in value of a party's investment due to the inability to use a newly built facility or one of its subcomponents. Returning to the airport terminal example, millions of dollars could have been invested into building a new baggage transport system only to find critical inefficiencies and problems following implementation. Assets and equipment have product life-cycles and when new assets are not active, loss of investments may be instantaneous. Other risks include gaps between expectations of the parties with engineering designs or plans and adverse impacts on public relations.

The size and complexity of a program may easily yield a variety of challenges that jeopardize the successful activation and or completion of the program or project. Thus, since any complex process, project or large-scale facility development project may take years to complete and involves the participation of a number of interdependent parties, some with conflicting priorities which may or may not be temporal in nature, effective quality management is key—one that looks at planning and programming as a continuous process across the lifecycle of a facility from inception to replacement.

Existing planning and programming tools possess functionality such as planning, estimation, scheduling, cost control, budget management, notification and reporting. Existing tools, however, are unable to identify gaps and risks associated with a project, identify consequences associated with the risks, and recommend mitigation strategies to address the risks. There is a need for a system and method that facilitates this process and assists a user in developing a comprehensive understanding of the design and operational risks and management strategies for these risks associated with a project.

### SUMMARY OF THE PRESENTLY CLAIMED INVENTION

In a first claimed embodiment, a method for generating a risk management report is claimed. Through this method, customer data from a computing device associated with a user over a network is received. The customer data includes a scope element of a project that is associated with both a current condition and a future condition. A knowledge based including the scope element is maintained. A gap based on the current condition and the future condition is identified. A risk is then based on the gap. A risk management report based on the risk is created and the risk management report based on the risk is transmitted to the user.

In a second claimed embodiment, a non-transitory computer-readable medium is claimed. The storage medium includes a computer program that is executable by a processor to perform a method for creating a risk management report. The method includes receiving customer data, the customer data including a scope element of a project that is associated with both a current condition and a future condition, maintaining a knowledge base including the scope element, identifying a gap based on the current condition and future condition, identifying a risk based on the gap, creating a risk management report based on the risk, and transmitting the risk management report to the user.

Embodiments of the method may be performed by a computing device in communication with a user or by the user itself. The method may also be performed by a processor executing a program contained on a computer-readable non-transitory storage medium.

### BRIEF DESCRIPTION OF THE FIGURES

FIG. 1 illustrates an exemplary architecture for generating a risk management report.

FIG. 2 illustrates an exemplary embodiment of a risk management system.

FIG. 3 illustrates an exemplary navigation interface for the risk management application.

FIG. 4 illustrates an interface to begin using the risk management system.

FIG. 5 illustrates an interface for entering data in the knowledge base.

FIG. 6 illustrates an interface for displaying details associated with a Standard Operating Procedure (SOP).

FIG. 7 illustrates an interface for providing details for a project.

FIG. 8 illustrates an interface for performing a gap and risk analysis.

FIG. 9 illustrates an interface for generating a quality management plan or strategy to mitigate or manage risks.

FIG. 10 illustrates a method for creating a risk management report.

FIG. 11 illustrates a computing system that may be used to implement an embodiment of the present invention.

### DETAILED DESCRIPTION

Embodiments of the present invention may provide a risk management application for generating a risk management report. Customer data that is received from a user associated with a computing device includes one or more scope elements of a program or project. The scope element is associated with information about current or existing conditions related to the scope element. The scope element is also associated with one or more future conditions. A future condition may include any desired or planned outcome or result. For example, consider an airport terminal that currently has 10 ticket counters with plans to expand to 15 ticket counters. The scope element may be ticket counters with 10 ticket counters as a current condition and 15 counters as a future condition. The scope element, current condition, and future condition are stored in a knowledge base along with a variety of information about the project including expected gaps and risks. A risk management system identifies gaps and relevant risks associated with the scope element based on the current condition and future condition. The risk management system then creates a risk management report that includes its findings about risks and recommendations for mitigating the risks. In one embodiment, a user may review the risk management report and either approve the recommended findings and recommendations as is or edit the report by adding to or deleting the findings to create a final risk management report.

In one embodiment, the risk management report further identifies one or more outcomes associated with a risk. For example, an outcome of a risk could be a schedule impact, cost impact, or change in scope. The risk management report may also identify a risk level associated with the risk.

In one embodiment, the risk management system interacts or communicates with a user or customer who is a stakeholder associated with the project in a unique manner that helps stakeholders understand project plans and designs and also helps communicate, manage and track project changes. Projects designs may be complex and difficult to understand by the stakeholders. The risk management system presents technical designs in an operational context thus facilitating stakeholder understanding of designs. Technical changes are communicated in a similar manner. When there is a change associated with the project, such as a schedule change, scope element change, or cost change, a notification may be sent by the risk management system to one or more stakeholders associated with the project. The notification may request approval or sign-off from each stakeholder. In another embodiment, the risk management system performs a stakeholder linkage or mapping. The risk management system identifies all relevant stakeholders associated with each scope element of a project or series of projects and determines the relationships between them. The linkage is established by the association of Standard Operating Procedures to all stakeholders that are involved and with the facilities, infrastructure and systems that are being designed and built by the project. This association is called SFOR Mapping and is a key step as a party who may not previously been associated with a project may be identified as a relevant stakeholder with legitimate interest in a project. Also, the SFOR mapping helps identify all current methods of doing work that may be impacted due to the scope of a project.

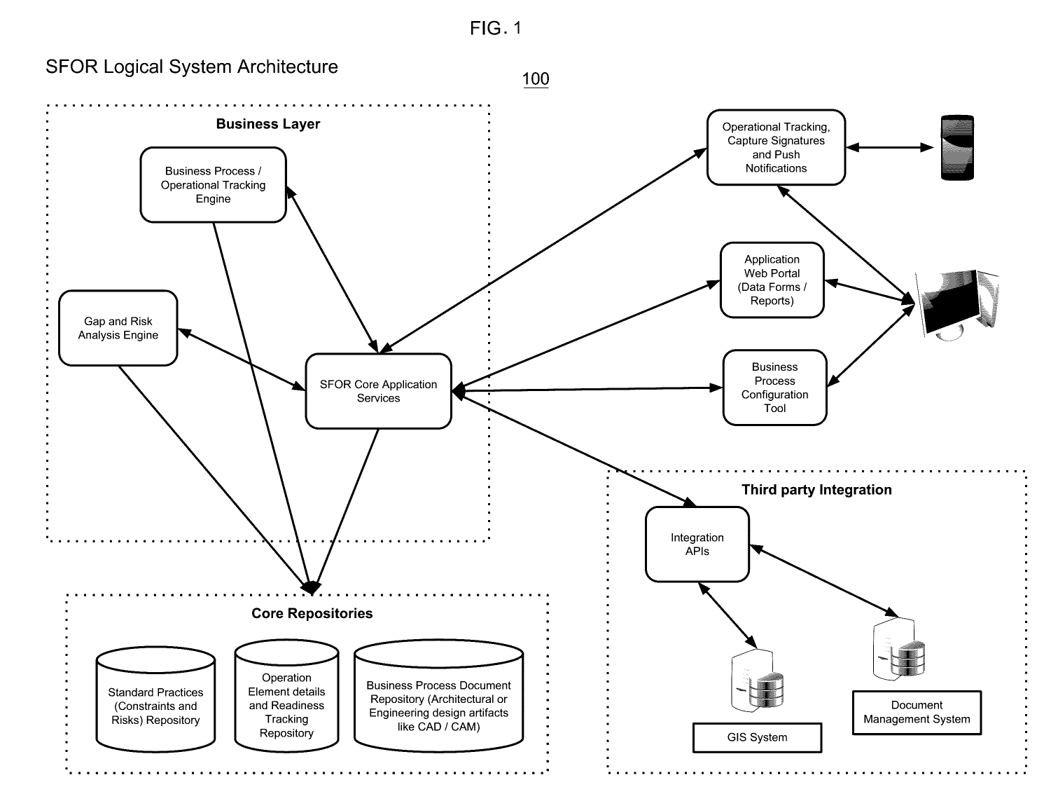

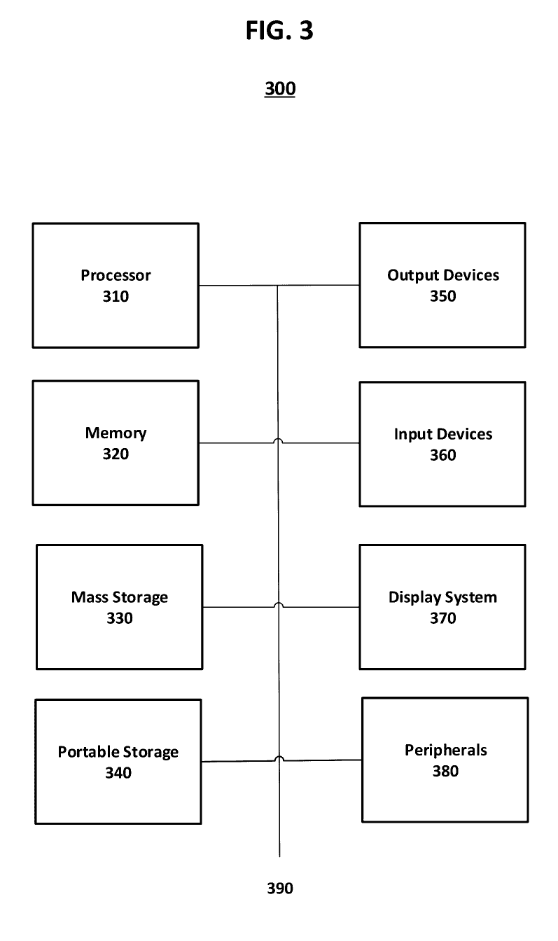

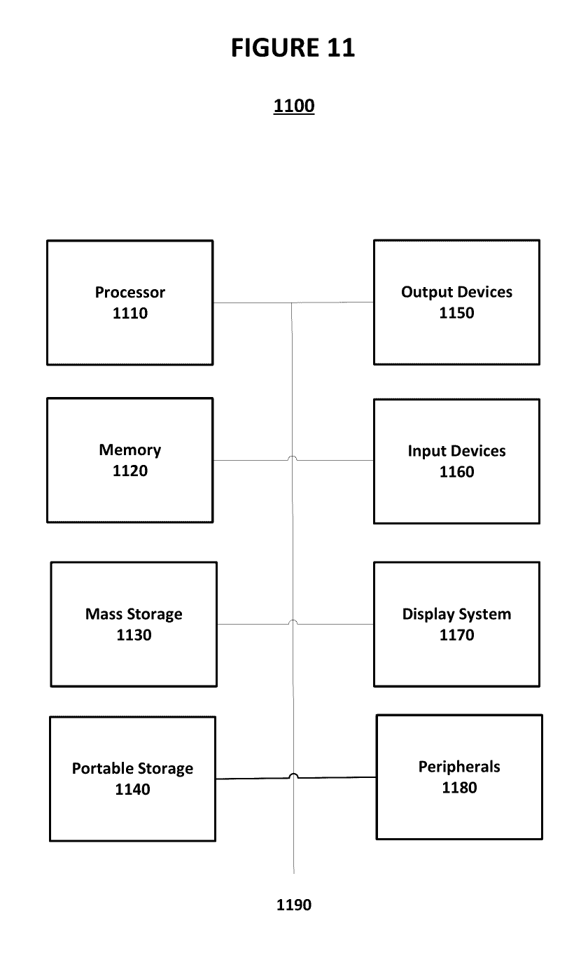

In some embodiments, the present risk management application may be implemented by one or more processors that execute instructions stored in one or more memory mediums. The executed code may result in the processor(s) generating and providing one or more graphical interfaces. FIGS. 3-11 illustrate examples of interfaces that may be used to implement embodiments of the present invention. An exemplary system for implementing the present risk management application is described in the context of FIGS. 1 and 11.

FIG. 1 illustrates an exemplary architecture for generating a risk management report. The parties involved may include a customer 110 (who will receive a finalized risk management report), user 120 and risk management system 200. In the illustrated embodiment, the user 120 communicates with the risk management system 200 which in turn can communicate back to the user 120. For example, customer 110 may provide its data to user 120 who provides or enters the data into risk management system 200. In another embodiment, the risk management system 200 can communicate directly with the customer 110.

Risk management system 200 may be associated with a plurality of users 120 and/or customers 110. A user 120 or customer 110 may access the risk management application using a computing device capable of accessing information over a communication network known in the art. Computing devices are inclusive of a general purpose computing device capable of accessing information over the network. Computing devices may be any computing device known in the art such as a workstation, laptop computer, net book computer, tablet computer, mobile device, cellular telephone, or the like that can communicate over the network. Computing devices include software and/or hardware capable of sending, receiving, and processing data such as client user data. A computing device may receive data from a user and send the data over a network to a server for processing.

In one embodiment, risk management system 200 is an application server that may be implemented in a general computing device. One or more software applications, tools, or modules may be stored in memory and executable by a processor (not shown) at the risk management server. An example of such a device is the general computing system illustrated in FIG. 11. The present risk management system may be implemented by one or more processors that execute instructions stored in one or more memory mediums. The executed instructions may result in the processor(s) generating and providing one or more graphical interfaces.

Using a computing device, for example, user 120 may subscribe (e.g., create an account) or register with the risk management system 200. Once the user 120 has registered with the risk management 200, the user 120 may perform a login (i.e., access account) and may access the risk management system 200 to provide customer data. In one embodiment, user 120 is an analyst or consultant representing or otherwise working for customer 110 in association with a particular program or project to create a risk management report for customer 110. User 120 may also be a stakeholder.

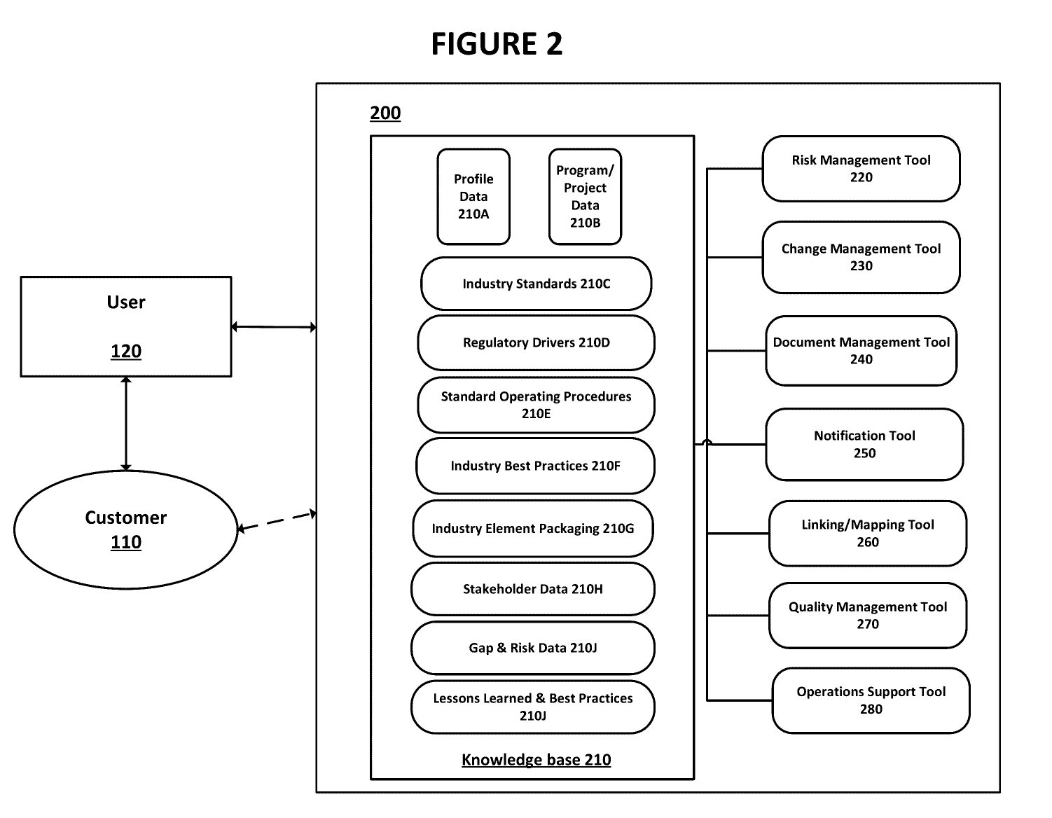

FIG. 2 illustrates an exemplary embodiment of a risk management system for generating a risk management report. The risk management system 200 may include but is not limited to the following: a knowledge base 210 and one or more tools executable by a processor such as a risk analysis tool 220, change management tool 230, document management tool 240, notification tool 250, linking/mapping tool 260, quality management tool 270, and operations transitional support tool 280. In one embodiment, risk management system 200 is an artificial intelligence expert system with a knowledge base 210 that has the capacity to learn. In FIG. 2, knowledge base 210 is integrated with risk management system 200. In another embodiment, knowledge base 210 may be separate from risk management system 200.

Knowledge base 210 stores a variety of information concerning a program or project for specific industries. If the project is a development project such as a terminal build of an airport, for example, knowledge base 210 may store profile data 210A, program/project data 210B, industry standards 210C, regulatory drivers 210D, standard operating procedures 210E, industry best practices 210F, industry element packaging 210G, stakeholder data 210H, gap and risk data 210I, and lessons learned and best practices 210J. Knowledge base 210 may include data relevant to a specific industry such as healthcare, aviation, military, or education, etc. In one embodiment, knowledge base 210 may be tailored or customized to a particular customer such as a municipality, government agency, school district, hospital, or an airport, etc.

Profile data 210A includes any data relating to a particular customer. This may include for example, business or entity name, contact information (i.e., address, phone number), account log-in information (i.e. screen name, passwords), key personnel, authorized users of the risk management application, and the like.

Program/project data 210B includes any data related to a particular program or project. This may include but is not limited to program or project titles, dates (i.e. milestone dates, start dates, end dates, approval dates, etc.), program or project descriptions, scope of project, justification for project or actions related to the project, status information (i.e. in progress, completed, delayed, overdue etc.), and the like.

Industry standards 210C include any established norm, requirement, practice, method, process, criteria or the like, that is adopted by convention by members of an industry either via a formal agreement or through best practices that are followed by members of the industry. In the aviation industry, for example, Aviation Security Manual document 8973 promulgated by the International Civil Aviation Organization (ICAO) provides standards and recommended practices for aviation security. As another example, the International Air Transport Association (IATA) formulates industry policy on various aviation issues.

Industry best practices 210D include any relevant information, recommendation, or suggestion found in the industry. Industry best practices 210D may be derived from sources such as trade journals, case studies, industry experts, newsletters, or any other publication.

Regulatory drivers 210E include any local, state, federal, international, or organizational norm, law, principle, or rule that may govern or otherwise affect the program or project. In an airport related program or project, for example, a regulatory driver may emanate from the Transportation Security Administration (TSA), the Federal Aviation Administration (FAA), a city ordinance, or a policy of a particular agency or department.

Standard operating procedures (SOPs) 210F include any established set of instructions, business processes or procedures, often step-by-step, that is used or followed in a given operation or situation to carry out routine operations or achieve a predictable, standardized, or desired result. SOPs are typically followed by relevant stakeholders when a particular situation occurs. There is, for example, a SOP that airport fire department and police department must follow when there is a fuel spill or a fire on a runaway. SOPs may be linked to one or more regulatory drivers. SOPs may also be linked to or more industry specific elements or scope elements. SOPs may also be linked to specific systems and facilities of a project.

Industry element packaging 210G applies to a program or project scope. Industry element packaging 210G allows for a framework to organize and/or analyze the program or project. A program or project is divided up into various elements with each element related to one or more SOPs. These elements are stored in knowledge base 210. The elements may be determined or identified from a physical or construction standpoint or operational standpoint. For example, industry element packaging for an airport may be divided into elements such as landside, airfield, baggage handling, terminal operations, etc. Each industry element packaging may further be associated with a sub-element or subcategory.

Stakeholder data 210H include any relevant data about any party, individual, department, organization or the like, with a legitimate interest in or concern for a program or project. Stakeholder data 210H may include identity data, contact information, location, relationship to one more other stakeholders. Stakeholder data may further include engineering design artifacts or other relevant documentation deemed necessary by a stakeholder. In the context of the construction of an airport terminal, for example, a stakeholder may include a retail concessionaire within the terminal, an airline tenant occupying the terminal, or an engineering professional servicing the terminal.

Gap and risk data 210I are associated with current and future conditions. A gap may include any problem, divergence or disparity caused by a missing part related to the project. A particular risk is associated with a gap. A project may plan, design and/or build something new or change something that already exists. In both cases, current conditions may change. This change may result in changes in future conditions that may create a gap between the current way of doing work i.e. current standard operating procedures and what is necessary to successfully operate after the project is completed and the change in current conditions is in place. In this case, the gaps and the resulting risks, due to the gaps, to successful project delivery are operational in nature and the risk management scope is focused on identifying and executing tasks necessary for operational readiness for the future conditions. Future conditions may be conceptualized by the designs of the work to be implemented by a project. In certain cases, it may be deemed that certain future conditions are not optimum for operations. In these cases, the gaps and the resulting risks, due to the gaps, to successful project delivery may be due to incorrect designs. The risk management scope, in these cases, may be focused on identify and executing tasks necessary to make timely changes to the designs to better meet operational and stakeholder needs and requirements.

Lessons learned and best practices 210J include lessons learned and best practices and all other on-the-job knowledge, know-how, training, and the like that may be relevant to a program or project. For example, managing warranty and training to ensure operational readiness and mitigating related risks is an important consideration one that can be easily missed.

Risk analysis tool 220 is a rules engine that compares the current state or conditions of a system/business process implementation to one or more future conditions to identify gaps and risks in implementing projects to stakeholder expectations and/or operational readiness. This is used to guide a user as they track the progress of the system. Risk analysis 220 may further compare the current and future conditions to other considerations stored in knowledge base 210 such as industry standards 210C, SOPs, regulatory driers 210D, SOPs 210E, industry best practices 210F, stakeholder data 210H, and other lessons learned and best 210J. practices to generate the risk management report.

Change management tool 230 manages and tracks changes to a program or project. Changes, for example, may relate to current or future conditions, scope, or a stakeholder. Change management tool 230 tracks where a change occurs (i.e., what element is affected) since a change may affect a previously identified gap, risk, or stakeholder. Change management tool 230 may also track changes to documents stored in knowledge base 210 including managing document versioning. Any changes to a program or project may result in notification tool 250 sending a real-time notification to one or more stakeholders.

Document management tool 240 manages facilitates change management version control of documents.

Notification tool 250 sends out a notification to all relevant parties when a change in the program or project occurs. Relevant parties include one or more stakeholders, a program/project manager, and/or a general contractor responsible for the program/project. In one embodiment a notification will indicate that approval or sign-off from the notification recipient is required. Notification tool 250 enables real time tracking of the risk management system 200, can gather needed approvals from a user 110 or customer 120, and may present notifications and alerts to a specific user 110, customer 120, or stakeholder as needed. Notification tool 250 further captures signatures and generates push notifications to be sent to user 120 and/or customer 110.

A change may occur before or after a risk management report is created by risk analysis tool 220. After a change in the program or project is tracked and logged by change management tool 230, a revised risk management report may be created by risk analysis tool 220. In one embodiment, the revised risk management report is created after approval or sign-off is received at the risk management system 200 from a relevant stakeholder or user 120 affected by the change.

Linking/mapping tool 260 is executable by a processor to create a mapping of an organization and its associated programs, program elements, projects and/or stakeholders so that a user can visualize, identify and understand the relationships between them.

Quality management tool 270 recommends a mitigation strategy for the gap(s) and risk(s) identified by risk analysis tool 220. Quality management tool 270 may further identify one or more tasks, actions, or activities that are required to mitigate the risks. Quality management tool 270 may also recommend which person, party, department, agency, etc. is responsible for completing such tasks, actions, or activities. Quality management tool 270 may also create and recommend budget requirements to execute the one or more recommended mitigation strategies.

Operations transitional support tool 280 tracks warranty and training information related to a program project. A complex, development project often includes complex systems (i.e. cooling systems, baggage handling systems, security systems, etc.) that may be associated with different warranty periods and initial activation start/end times. A complex system may also require training of various personnel to ensure proper operation and maintenance. Since such systems may begin activation at different times and/or have different warranty periods, operations transitional support tool 280 tracks these different time periods and notification tool 260 notifies relevant users, customers, stakeholders etc. when time periods are about to expire or have expired, for example. Operations transitional support tool 280 also tracks the life cycle costs of a program/project. Life cycle costs include any cost to address an identified gap or risk such as operations and maintenance costs.

FIG. 3 illustrates an exemplary navigation interface for the risk management application. Interface 300 allows user 120 to see and navigate through the various parts of the application and includes SFOR Setup 310 and “Project Setup 320. “SFOR” refers to “Systems, Facilities, Operations Readiness (SFOR™)” a process developed by Birdi & Associates, Inc. of Los Angeles, Calif. In the SFOR Setup 310 of the risk management application, a user 120 provides customer data which is stored in knowledge base 210. Customer data may include but is not limited to SOPs 310A, stakeholder data 310B, elements 310C, systems 310D and facility/infrastructure 310E. Customer data includes current and future conditions associated with a scope element of a project. After providing customer data, user 120 may proceed to the Project Setup 320 to provide details about a specific project. A project may be organized into various “SFOR elements” or scope elements using SFOR setup 320A. For example, an airport may be organized into scope elements such as “Airlines,” “Terminal,” “Gate Operations” and “Landside.” A gap and risk mapping and analysis 320B may be performed by the risk analysis tool 220 based on each scope element. The risk analysis results in the creation of a risk management report which identifies and presents one or more gaps and relevant risks associated with the scope element based on at least current conditions and future conditions.

Following use of the gap and risk mapping and analysis, a user may proceed to quality management 330C. Risk analysis tool 220 may also recommend a way to mitigate or address the identified gaps(s) and risk(s). The risk management application may also create a quality management plan which includes recommends how to a mitigation strategy or plan. Quality management tool 270 generates strategies for executing a mitigation strategy including identifying requisite tasks or activities, the relevant personnel or party to complete the tasks or activities, the timeline or deadlines associated with executing the strategy and budget requirements for the same.

Project setup 320 also includes change management 320D to track any changes in the risk management system.

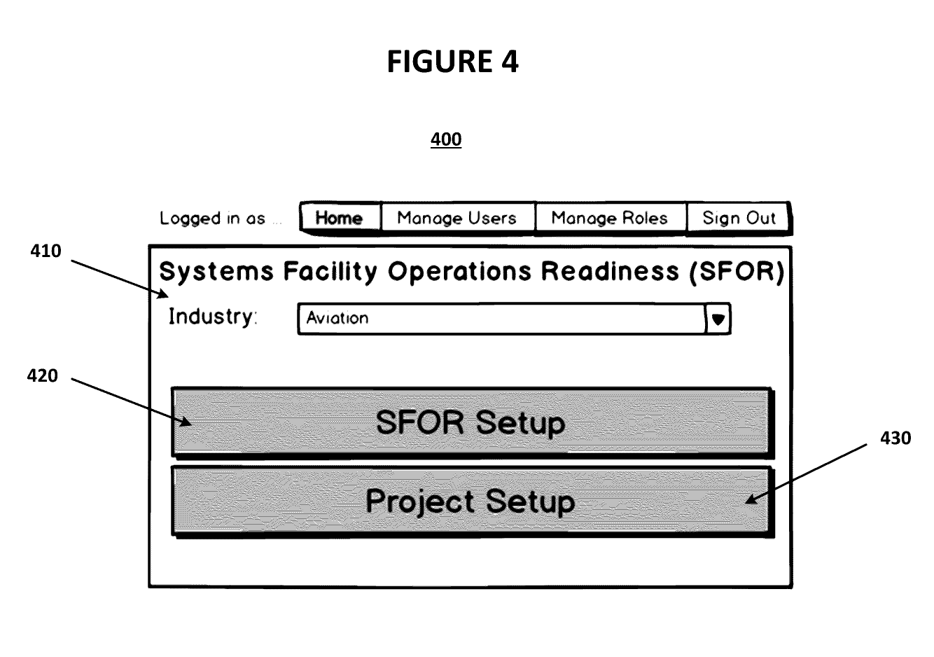

FIG. 4 illustrates an interface to begin using the risk management system. Interface 400 shows an exemplary menu screen for the risk management system 200. User 120 may first select the applicable industry 410. As shown in FIG. 4, user has selected the “Aviation” industry. In another embodiment, (not shown) a user may select a particular customer or client rather than an industry. User 120 may then provide or input data for the selected industry by selecting the SFOR Setup button 420. User 120 may also manage an existing project or enter new project data in the selected industry by selecting the Project Setup button 430.

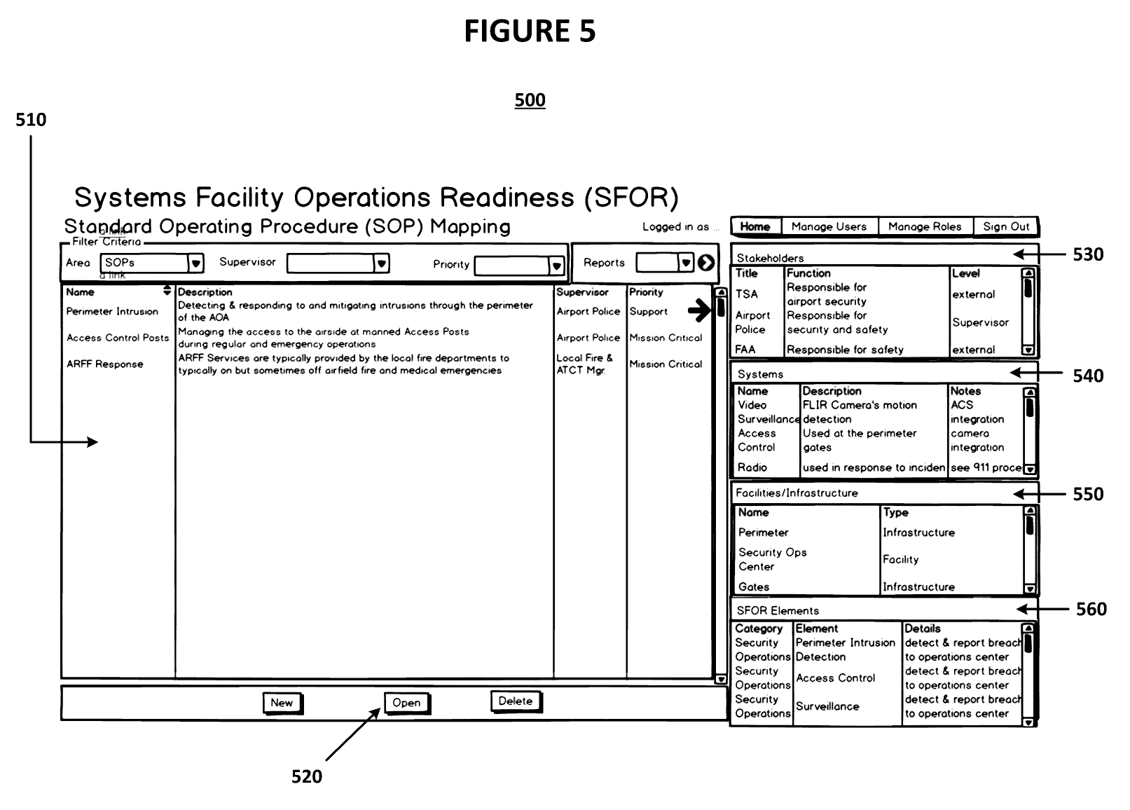

FIG. 5 illustrates an interface for entering data into the knowledge base. Interface 500 may be an initial data entry point for the knowledge base 210. Interface 500 may be a SOP mapping page that includes a main grid 510 for showing all SOPs in the knowledge base 210. SOPs may be associated with one or more identifier such as “Name,” “Description,” “Supervisor,” and “Priority.” “Supervisor” refers to the stakeholder or owner (i.e. individual, department, or other entity) responsible for the selected SOP. “Priority” refers to the level of importance of the SOP to the stakeholders as it relates to the scope of the project. For example, “Priority” may be described as “Mission Critical,” “Support,” or “Non-Mission Critical.” User 120 may select any of the SOPs listed in main grid 510, for example, by double-clicking on the SOP or highlighting the desired SOP and pressing or selecting an Open 520 button. Selecting a particular SOP listed in main grid 510 results in related information to be displayed in one or more minor grids. For example, selection of the “Perimeter Intrusion” SOP in main grid 510 results in relevant information to be displayed in minor grids Stakeholders 530, Systems 540, Facilities/Infrastructure 550, and SFOR Elements 560.

Interface 500 may also include filter criteria 570. For example, the filter criteria of “Area” in filter criteria 570 allows user 120 to select which data should be displayed in the main grid 510. A user may select “SOPs,” “Stakeholders,” “Systems”, “Facilities/Infrastructure” or SFOR Elements. As shown in FIG. 5, a user has selected or filtered based on “SOPs” as the criteria which is why SOPs is shown in the main grid. User 120 may also filter on other criteria such as “Supervisor” or “Priority.” Information entered into interface 500 may be stored in knowledge base 210.

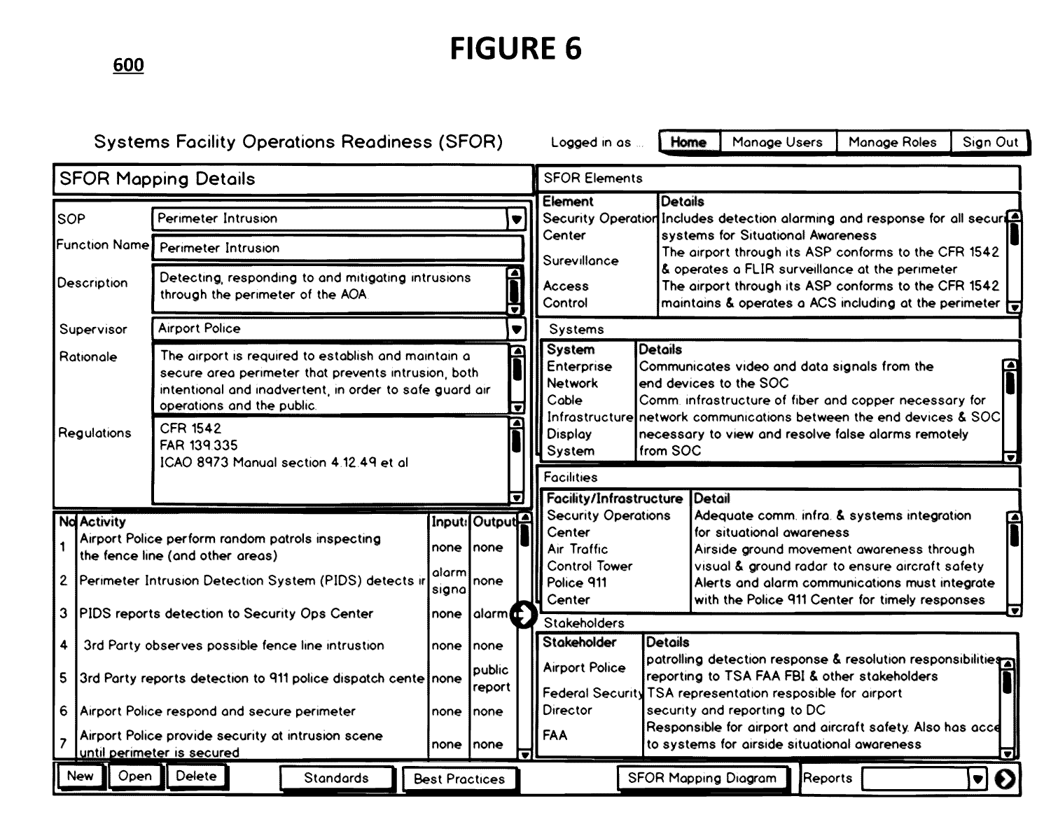

FIG. 6 illustrates an interface for displaying details associated with a Standard Operating Procedure (SOP). Interface 600 shows details regarding the “Perimeter Intrusion” SOP shown in main frame 510. Selecting the “New” 610 button allows a blank screen to open so that user 120 may enter and/or save a new SOP. Moving from interface 500 to interface 600 is consistent with risk management system's 200 ability to link intangible SOPs with tangible parts, systems, facilities of the project that are being built, constructed, designed, or implemented. The SOP level information in interface 600 includes standards 620, regulations 630 and best practices 640 while the activity level information 650 (one SOP may have multiple activities) is related to the rest of the boxes in interface 600 for SFOR elements, systems, facilities/infrastructure, stakeholders. Thus, selecting a particular activity will generate one or more records to populate the boxes for SFOR elements, systems, facilities/infrastructure, stakeholders. Interface 600 allows user 120 to add one or more activities. For each activity, user 120 may enter relevant data related to SFOR elements, systems, facilities and stakeholders. Interface 600 allows for a work flow diagram that captures SOP information as it relates to systems, facilities, operations, stakeholders, etc. related to the project. Information entered into interface 600 may be stored in 210.

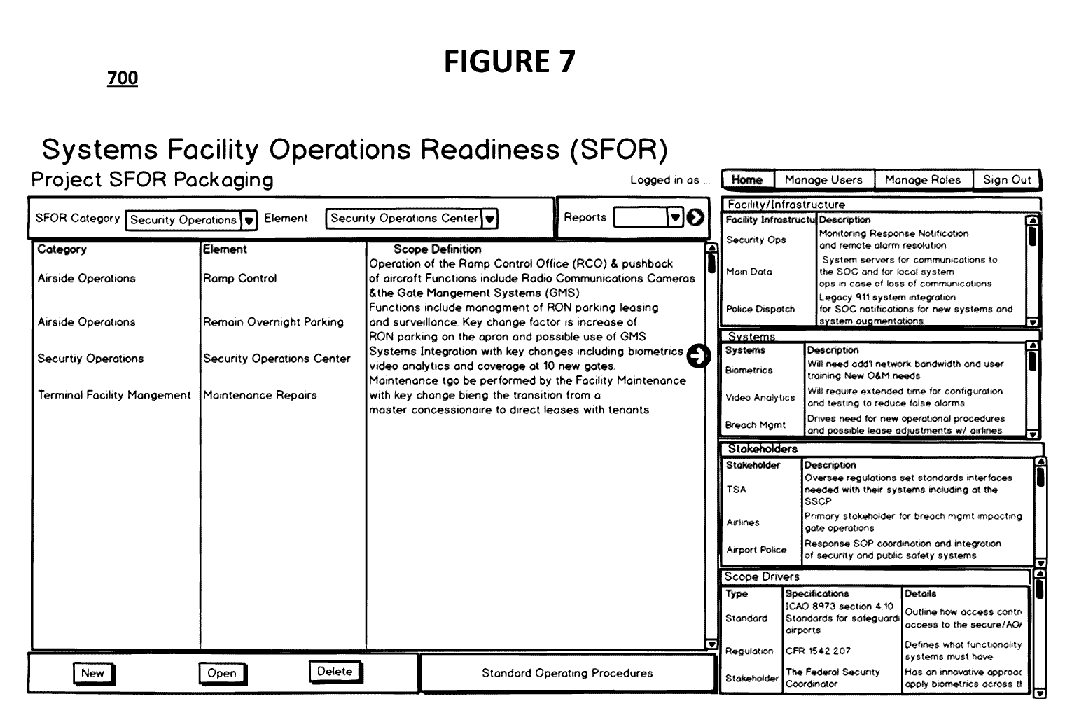

FIG. 7 illustrates an interface for providing details for a project. Interface 700 shows setup screen for entering data for a specific project. For example, user 120 may use interface 700 to provide data for a project at a specific worksite. Interface 700 allows a user to baseline a project's scope and organize a project into specific categories and elements. Information entered into interface 700 may be stored in knowledge base 210. Knowledge base 210 is fully leveraged and used and all elements are established to cover the scope of the project.

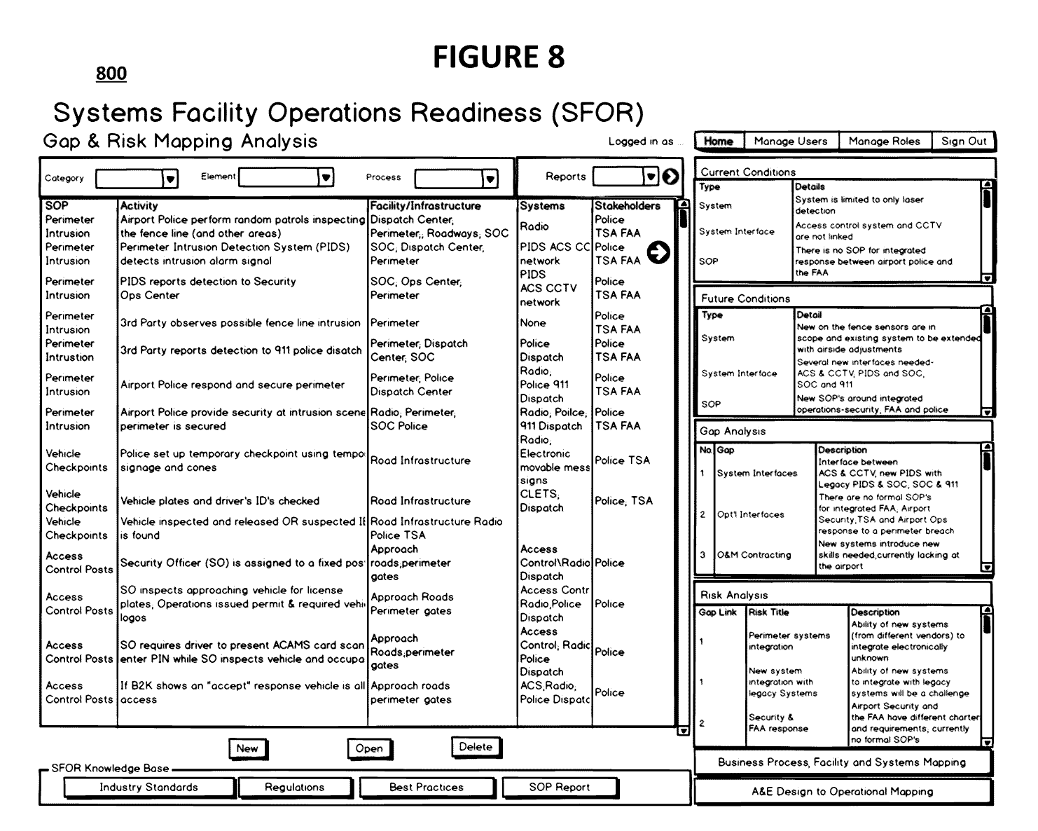

FIG. 8 illustrates an interface for performing a gap and risk analysis. Interface 800 may be used to enter data by category, element and/or process. Interface 800 may also be used to enter all of steps, instructions, and/or details related to a SOP. The risk analysis tool 220 helps identify each step in the process, facilities/infrastructure, systems and stakeholders involved, current conditions, future conditions, and any gap(s). Risk analysis tool 220 may then identify a project delivery risk based on the gap. Interface 800 also allows user 120 to finalize details for a SOP relevant to the project as well as to provide any architecture and engineering design files with capability to overlay operational features for an operational analysis of the designs. Interface 800 may also be used to provide additional details (i.e., relating to industry standards, regulations, best practices, and SOP) to data stored in knowledge base 210. Information entered into interface 800 may be stored in knowledge base 210.

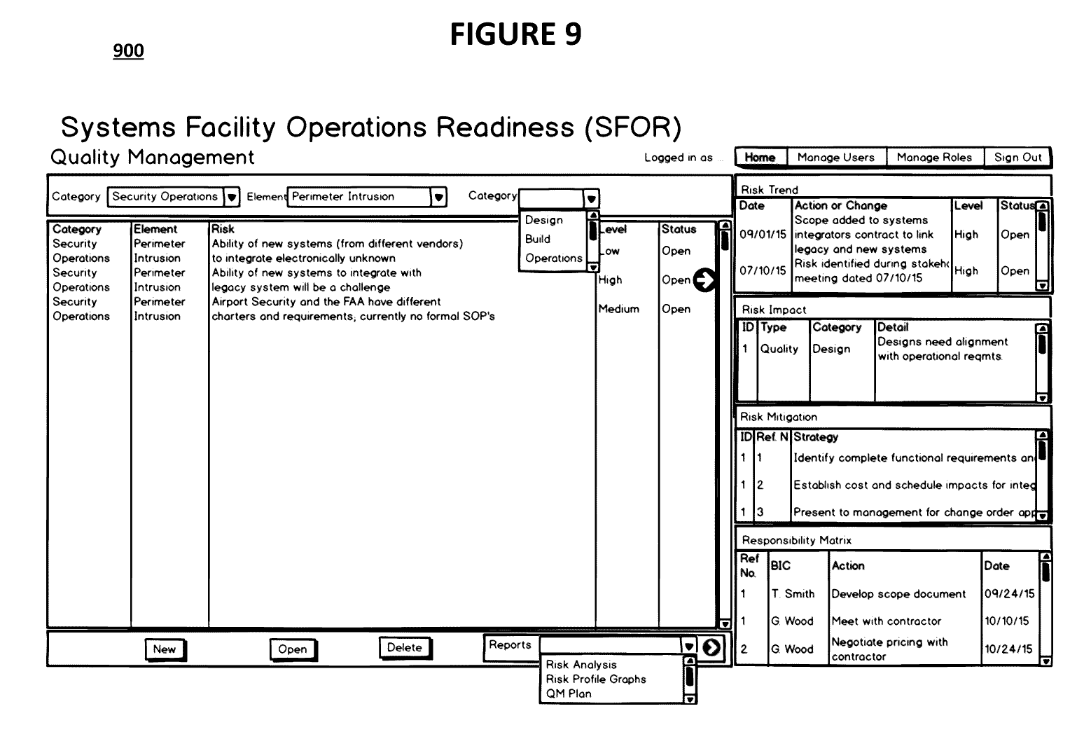

FIG. 9 illustrates an interface for generating a quality management plan or strategy to mitigate or manage risks. In one embodiment, a risk may be categories. For example, a risk may be categorized as a “design risk” or “operational risk.” A risk may be organized by elements. A risk may be also be organized by risk level (i.e., low, medium, high). Interface 900 allows for user 120 to capture or provide data regarding changes in the risk profile of a project such as a risk profile due to project scope or mitigation steps taken. Risk management system 200 may generate risk management reports such as “Risks Analysis,” “Risk Profile Graphics,” and “QM (Quality Management) Plan” as shown in interface 900. In one embodiment, risk analysis tool 220 generates the “Risk Analysis” Report” and “Risks Analysis Reports.” In one embodiment, quality management tool 270 generates the “QM Plan.” Reports that are generated by risk management system 200 may be stored in knowledge base 210.

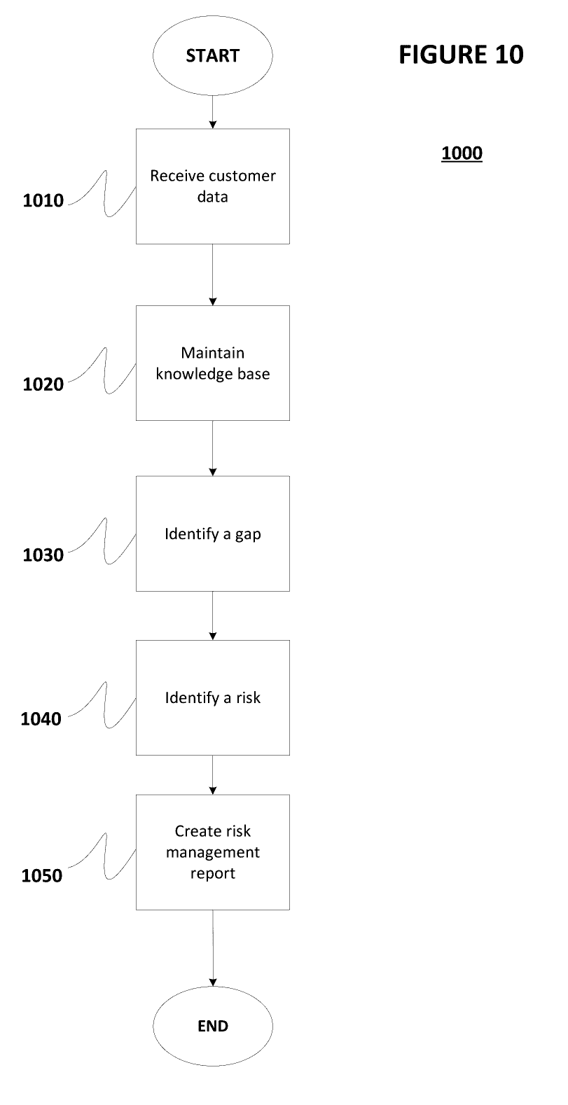

FIG. 10 illustrates a method for creating a risk management report. The steps identified in FIG. 10 (and the order thereof) are exemplary and may include various alternatives, equivalents, or derivations thereof including but not limited to the order of execution of the same. The steps of the method of FIG. 10 (and its various alternatives) may be embodied in hardware or software including a non-transitory computer-readable storage medium (e.g., an optical disc or memory card) having instructions executable by a processor of a computing device. A user may launch or activate the method of FIG. 10 by opening or activating the application in a computing device such as a mobile device or tablet.

The method 1000 of FIG. 10 may result in the creation of a risk management report that identifies one or more risks associated with a project. At step 1010, risk management 200 receives customer data from a computing device associated with a user 120. Customer data may include profile data 210A, program/project data 210B, industry standards 210C, regulatory drivers 210D, standard operating procedures 210E, industry best practices 210F, industry element packaging 210G, stakeholder data 210H, gap and risk data 210I, and lessons learned and best practices 210J. Customer data includes one or more scope elements associated with a program or project as well as current and future conditions associated with the scope element all of which are stored in knowledge base 210.

At step 1020, a knowledge base is maintained regarding a customer and a variety of information related to one or more projects. A current condition and future condition is associated with a gap which may be related to a risk.

At step 1030, a gap is identified by risk analysis tool 220. A gap is based on at least one or more current and future condition associated with a scope element. A gap is further identified based on other information stored in knowledge base 210 such as industry standards 210C, regulatory drivers 210D, SOPs 210E, industry best practices 210F, stakeholder data 210H, and lessons learn and best practices 210J.

At step 1040, a risk is identified by risk analysis tool 220. A risk is based on at least one risk. A risk may further be identified based on other information stored in knowledge base 210 such as industry standards 210C, regulatory drivers 210D, SOPs 210E, industry best practices 210F, stakeholder data 210H, and lessons learn and best practices 210J.

At step 1050, a risk management report is created by risk analysis tool 220. The risk management report summarizes, presents and identifies the gaps and risks based on a scope element of the project. The risk management report may also present strategies and/or recommendations for mitigating the identified risks. In one embodiment, quality management tool 270 recommends mitigation strategies for the gaps and risks identified by risk analysis tool 220. Quality management tool 270 further identifies one or more tasks, actions, or activities that are required to mitigate the risks and a timeline for completing such tasks, actions, or activities. Quality management tool 270 also recommends which persons or parties are responsible for completing such tasks, actions, or activities. Quality management tool 270 also creates and recommends budget requirements to execute the one or more recommended mitigation strategies.

The risk management report may then be transmitted to user 120 for review and/or approval. User 120 may accept the risk management report as is or edit the report to generate a final risk management report. User 120, for example, may edit the report by adding gap or risk information or deleting some of the findings in the risk management report.

FIG. 11 illustrates a computing system 1100 that may be used to implement the present technology. System 1100 of FIG. 11 may be used to implement a computing device, server (i.e. application server, network server), and data repositories (i.e. knowledge base) in the context of the system of FIG. 2. The computing system 1100 of FIG. 11 includes one or more processors 1110 and memory 1120. Main memory 1120 stores, in part, instructions and data for execution by processor 1110. Main memory 1120 can store the executable code when in operation. Main memory 1120 may also include a repository such as the repository illustrated in FIG. 1. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. The components, however, may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive or an optical disk drive, is a non-volatile storage device for storing data and instructions for use by processor unit 1110. Mass storage device 1130 may store the system software for implementing embodiments of the present invention for purposes of loading software into main memory 1120.

Portable storage device 1140 operates in conjunction with a portable nonvolatile storage medium, such as a floppy disk, compact disk or Digital video disc, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, or a pointing device, such as a mouse, a trackball, stylus, or cursor direction keys. Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 may receive textual and graphical information, and process the information for output to the display device.

Peripherals 1180 may include any type of computer support device to add additional functionality to the computer system. For example, peripheral device(s) 1580 may include a modem or a router.

The components contained in the computing system 1100 of FIG. 11 are those typically found in computer systems that may be suitable for use with embodiments of the present invention and are intended to represent a broad category of such computer components that are well known in the art. Thus, the computing system 1500 of FIG. 11 may be a personal computer, hand held computing device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows

SFOR-001 Mobile, or iOS. The steps of the method of FIG. 10 (and its various alternatives) may be performed by a module or engine stored on a computer readable storage medium (e.g., optical disc, memory card, etc.) comprising instructions executable by a processor of a computing device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claims and otherwise appreciated by one of ordinary skill in the art.

What is claimed is:

1. A method for creating a risk management report, comprising:
receiving customer data from a computing device associated with a user over a network, the customer data including a scope element of a project that is associated with both a current condition and a future condition;
executing instructions stored in memory, wherein execution of the instructions by a processor:
maintains a knowledge base including the scope element,
identifies a gap based on the current condition and future condition,
identifies a risk based on the gap, and
creates a risk management report based on the risk.
transmitting the risk management report to the user.

2. The method of claim 1, wherein the scope element is associated with a standard operating procedure.

3. The method of claim 1, further comprising transmitting a notification to the user following a change in the scope element project, wherein the change is a schedule delay.

4. The method of claim 1, wherein the execution of the instructions by the processor further generates a recommendation for mitigating the risk.

5. The method of claim 4, wherein the risk management report includes a recommendation for mitigating the risk.

6. The method of claim 1, wherein the project is associated with the development of a facility.

7. The method of claim 1, wherein the execution of the instructions by the processor further:
identifies a stakeholder associated with a system of the project, and
requests approval from the stakeholder of a change in the scope element.

8. The method of claim 1, wherein the execution of the instructions by the processor further:
identifies a stakeholder associated with a system of the project, and
maps the stakeholder to a system of the facility.

9. The method of claim 1, wherein the execution of the instructions by the processor further identifies an outcome associated with the risk.

10. The method of claim 9, wherein the outcome is a schedule delay.

11. The method of claim 9, wherein the outcome is a change in the scope element.

12. The method of claim 9, wherein the outcome is a cost impact.

13. The method of claim 1, wherein the execution of the instructions by the processor further associates a risk level with the risk.

14. The method of claim 1, wherein the execution of the instructions by the processor further creates a quality management plan that includes a risk mitigation strategy.

15. A non-transitory computer-readable storage medium having embodied thereon a program, the program being executable by a processor to perform a method for creating a risk management report, the method comprising:
receiving customer data a user, the customer data including a scope element of a project that is associated with both a current condition and a future condition;
maintaining a knowledge base including the scope element;
identifying a gap based on the current condition and future condition;
identifying a risk based on the gap;
creating a risk management report based on the risk; and
transmitting the risk management report to the user.
